(19) United States
(12) Patent Application Publication
(10) Pub. No.: US 2016/0158799 A1
(43) Pub. Date: Jun. 9, 2016

(54) PROCESS FOR PRODUCING INTERMEDIATE TRANSFER BELT

(71) Applicant: Konica Minolta, Inc., Tokyo (JP)

(72) Inventors: Tsuyoshi SHIMODA, Tokyo (JP); Junji Ujihara, Tokyo (JP); Takayuki Suzuki, Tokyo (JP); Ryuji Kitani, Tokyo (JP)

(21) Appl. No.: 14/958,458

(22) Filed: Dec. 3, 2015

(30) Foreign Application Priority Data
Dec. 9, 2014 (JP) 2014-248903

(51) Int. Cl. B05D 3/06; G03G 15/16

(52) U.S. Cl. CPC B05D 3/067; G03G 15/162

(57) ABSTRACT

The process of the present invention for producing an intermediate transfer belt is a process for producing an intermediate transfer belt of an electrophotographic image forming apparatus. The intermediate transfer belt has a surface layer composed of a cured resin on a substrate layer composed of polyphenylene sulfide resin. A coating film formed by coating a surface of the substrate layer with a curing composition containing a polymerizable component is irradiated with curing light including light with a specific wavelength emitted from an LED light source, to form the surface layer composed of the cured resin by polymerization of the polymerizable component.

### CROSS REFERENCE TO RELATED APPLICATIONS

This application is entitled to and claims the benefit of Japanese Patent Application No. 2014-248903, filed on Dec. 9, 2014, the disclosure of which including the specification, drawings and abstract is incorporated herein by reference in its entirety.

### BACKGROUND OF THE INVENTION

1. Field of the Invention

The present invention relates to a process for producing an intermediate transfer belt.

2. Description of Related Art

Recently, in electrophotographic full-color image forming apparatuses, an image forming method with an intermediate transfer system has been often employed in which, for example, latent images formed respectively on photoconductors of the respective colors of yellow, magenta, cyan, and black are developed by toners of the respective colors, and the obtained toner images of the respective colors are superimposed on an intermediate transfer belt and held temporarily, which toner images superimposed on the intermediate transfer belt are transferred onto a recording medium such as paper. With the intermediate transfer process-image forming method, it becomes possible to achieve advantages of increasing the speed of image formation, obtaining an image forming property which is not dependent on paper-type (capable of forming an image on various types of paper), and also copying a full page.

As the intermediate transfer belt for use in such an image forming method, a belt having a surface layer composed of a hard resin such as a cured resin for enhancing wear resistance and scuff resistance formed on the surface of a substrate layer composed of a soft resin has been proposed (see Japanese Patent Application Laid-Open No. 2008-46463). According to the intermediate transfer belt provided with the above-mentioned substrate layer, it becomes possible to reduce the size of the image forming apparatus. When using, for example, a thermoplastic resin such as polyphenylene sulfide resin (PPS) or polycarbonate resin (PC) as the soft resin for forming that substrate layer, it becomes possible to easily manufacture such a substrate layer with an endless belt shape by means of extrusion molding.

However, the polyphenylene sulfide resin easily undergoes changes in its crystal structure due to heat. Therefore, when forming a surface layer composed of a cured resin on a substrate layer composed of polyphenylene sulfide resin, the substrate layer may be subjected to heat generated by irradiation with light for synthesizing the cured resin (curing light). Due to the heat, the crystal structure of the polyphenylene sulfide resin composing the substrate layer changes, thus lowering the bending resistance as well as creep resistance of the intermediate transfer belt to be obtained, and as a result the durability as well as transfer quality of the intermediate transfer belt may sometimes become insufficient.

Further, when a polymerizable component for forming the cured resin of the surface layer contains polyurethane acrylate, it takes a long time for curing, which increases the total amount of heat generated by irradiation with curing light, and thus particularly the bending resistance and creep resistance are remarkably lowered.

### SUMMARY OF THE INVENTION

The present invention has been made taking into consideration the above-mentioned circumstances, and an object of the present invention is to provide an intermediate transfer belt excellent in bending resistance and creep resistance.

As a method for achieving the above-mentioned object of the present invention, the present invention provides a process for producing an intermediate transfer belt for transferring a toner image formed on a photoconductor to a recording medium in an electrophotographic image forming apparatus, the intermediate transfer belt having a surface layer composed of a cured resin on a substrate layer composed of polyphenylene sulfide resin, the method comprising irradiating a coating film formed by coating a surface of the substrate layer with a curing composition containing a polymerizable component, with curing light emitted from an LED light source, which curing light includes neither light with a wavelength of less than 320 nm nor light with a wavelength of more than 405 nm, but includes light with a wavelength of 320 nm or more and 405 nm or less, to form the surface layer composed of the cured resin by polymerization of the polymerizable component.

In the process of the present invention for producing an intermediate transfer belt, the curing light is preferably light with a spectrum having a single peak.

In the process of the present invention for producing an intermediate transfer belt, the polymerizable component preferably contains a polyurethane acrylate.

In the process of the present invention for producing an intermediate transfer belt, the polymerizable component preferably contains a multifunctional (meth)acrylate having at least two (meth)acryloyloxy groups in a molecule.

In the process of the present invention for producing an intermediate transfer belt, the surface layer preferably has a thickness of 1.0 μm or more and 5.0 μm or less.

### BRIEF DESCRIPTION OF DRAWINGS

The present invention will become more fully understood from the detailed description given hereinbelow and the appended drawings which are given by way of illustration only, and thus are not intended as a definition of the limits of the present invention, and wherein:

FIG. 1A is an explanatory sectional view illustrating an example of a configuration of an intermediate transfer belt according to Embodiment 1 of the present invention, and FIG. 1B is an explanatory sectional view illustrating an example of a configuration of an intermediate transfer belt according to Embodiment 2 of the present invention;

FIG. 2 is a spectrum of light radiated from a light source, for use in a process of the present invention for producing an intermediate transfer belt;

FIG. 3 is a spectrum of light radiated from a light source, for use in a process for producing an intermediate transfer belt according to Comparative Example 1; and

FIG. 4 is a spectrum of light radiated from a light source, for use in a process for producing an intermediate transfer belt according to Comparative Example 2.

### DESCRIPTION OF THE PREFERRED EMBODIMENTS

Hereinafter, the present invention will be described in detail.

[Process for Producing Intermediate Transfer Belt]

A process of the present invention for producing an intermediate transfer belt is a process for producing an intermediate transfer belt having a surface layer composed of a cured resin on a substrate layer composed of polyphenylene sulfide resin, for transferring a toner image formed on a photoconductor to a recording medium in an electrophotographic image forming apparatus.

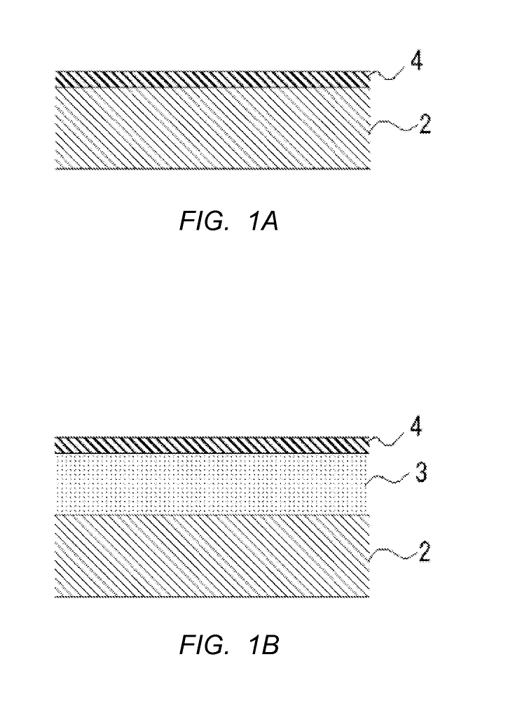

The intermediate transfer belt according to the present invention is, for example, a belt with an endless belt shape, and specifically has a surface layer on a substrate layer. Surface layer 4 may be either formed directly on substrate layer 2 as illustrated in FIG. 1A, or formed on intermediate layer 3 on substrate layer 2, the intermediate layer 3 being composed of an elastic body or an adhesive, as necessary, as illustrated in FIG. 1B.

[Method of Forming Substrate Layer 2]

Examples of the method of forming substrate layer 2 include: a method of forming substrate layer 2 by coating a die or the like is coated with a coating liquid containing a resin for forming substrate layer 2 (hereinafter, also referred to as “resin for substrate layer”) and a solvent dissolving the resin therein; and a method of directly molding the resin for substrate layer. The latter method is preferred.

As the latter method, extrusion molding, inflation molding or the like can be used.

Description will be made for the case of employing extrusion molding. First, a raw material composition composed of a resin for substrate layer and various types of additives is melted and kneaded to give a resin pellet. Next, the resin pellet is charged into a single-screw or twin-screw extruder provided with an annular die, for example, to extrude the molten resin pellet from a tubular resin discharge port at the tip of the annular die. Thereafter, a tubular body of the extruded resin composition for a substrate is externally fitted onto a cooling tube having a cooling mechanism, thereby solidifying the resin for substrate layer to mold the resin into an endless belt shape. Thus, substrate layer 2 can be manufactured.

At that time, as a means for not causing the polyphenylene sulfide resin to crystallize, it is preferable to cool the tubular resin for substrate layer with water, air, cooled metal block, or the like immediately after the resin is discharged from the annular die. Specifically, it is possible to adopt a configuration in which a heat insulation material is provided between the annular die and the cooling tube, to quickly take heat of the tubular resin for substrate layer (tubular body) discharged from the annular die. Water whose temperature is controlled constantly at 30° C. or lower is allowed to be circulated inside the cooling tube.

Further, the tubular resin for substrate layer discharged from the annular die may also be drawn at high speed for allowing it to be a thin film, to increase the cooling speed. In this case, the drawing speed is 1 m/min or higher, and particularly preferably 2 to 7 m/min.

When employing inflation molding, a molten resin pellet is formed into tubular form in a die, into which air is blown with a blower to cool the resin, to mold it, for example, into an endless belt shape thereby enabling substrate layer 2 to be manufactured.

The above-mentioned resin for substrate layer is a polyphenylene sulfide resin. The polyphenylene sulfide resin is a thermoplastic resin having a structure in which phenylene units and sulfur atoms are arranged alternately.

The phenylene unit of the polyphenylene sulfide resin composing substrate layer 2 may have a substituent, and may be an o-phenylene unit, m-phenylene unit or p-phenylene unit, or may be a mixture thereof. It is preferable that the configuration of the phenylene unit contains at least a p-phenylene unit, and the p-phenylene unit content is 50% or more to the total amount of the phenylene units. Particularly, the phenylene unit is preferably a non-substituted p-phenylene unit only.

Particularly, substrate 2 preferably contains as an additive a conductive agent, since it enables electric resistance to be controlled.

As the conductive agent, it is possible to use carbon black; metal powders such as aluminum, and nickel; metal oxides such as titanium oxide; and conductive polymer compounds such as quaternary ammonium salt-containing methyl polymethacrylate, polyvinylaniline, polyvinylpyrrole, polydiacetylene, polyethylene imine, boron-containing polymer compounds, and polypyrrole. These conductive agents may be used singly or in combination.

Substrate layer 2 may contain other additives such as an antioxidant, and/or a lubricant, as necessary.

Substrate layer 2 preferably has a wall thickness of 50 to 250 μm, in consideration of mechanical strength, image quality, production cost, and the like.

[Method of Forming Surface Layer 4]

Surface layer 4 can be formed, for example, by applying a composition containing a polymerizable component for forming a cured resin of surface layer 4 and a photopolymerization initiator (hereinafter, also referred to as “coating liquid for surface layer”) to form a coating film, and then irradiating the coating film with curing light, and as a result an intermediate transfer belt is produced.

The coating liquid for surface layer contains at least a polymerizable component and a photopolymerization initiator, and may also contain additives such as surface-treated metal oxide microparticles and/or solvent, as necessary.

As the polymerizable component, it is preferable to add a polyurethane acrylate, a multifunctional (meth)acrylate, a polymerizable compound having a low surface energy group other than the multifunctional (meth)acrylate, or the like. It is noted that “(meth)acrylate” is a general term for methacrylate and acrylate, and means one or both thereof.

[Polyurethane Acrylate]

The polyurethane acrylate is a polymer having a urethane bond and also having at least one acryloyloxy group in a molecule. Examples of the polyurethane acrylate include a polyurethane acrylate having a urethane bond in a main chain, with at least one acryloyloxy group being bonded to a terminal of the main chain or to a side chain.

The polyurethane acrylate is preferably contained in the polymerizable component at a ratio of 30 to 70 wt %.

[Multifunctional (Meth)Acrylate]

The multifunctional (meth)acrylate has at least two (meth)acryloyloxy groups in a molecule, and is used for demonstrating wear resistance, toughness, and adhesiveness of surface layer 4 of the intermediate transfer belt. It is noted that “(meth)acryloyloxy group” is a general term for a methacryloyloxy group or an acryloyloxy group, and means one or both thereof.

Specifically, examples of the multifunctional (meth)acrylate include difunctional monomers such as bis(2-acryloxyethyl)-hydroxyethyl-isocyanurate, 1,6-hexanediol diacrylate, 1,4-butanediol diacrylate, 1,9-nonanediol diacrylate, neopentylglycol diacrylate and hydroxypivalate neopentylglycol diacrylate, and urethane diacrylate; and multifunctional monomers including tri- or higher functional groups such as trimethylolpropane triacrylate (TMPTA), pentaerythritol triacrylate, tris(acryloxyethyl)isocyanurate, ditrimethylolpropane tetraacrylate, pentaerythritol tetraacrylate (PETTA), dipentaerythritol hexaacrylate (DPHA), urethane polyacrylate, and an ester compound synthesized from a polyalcohol, a polybasic acid and (meth)acrylic acid, for example, an ester compound synthesized from trimethylolethane/succinic acid/acrylic acid at a molar ratio of 2:1:4.

In order to impart hard-coat properties to a coating film, it is preferable to use a multifunctional acrylate including tri- or higher functional groups.

The multifunctional (meth)acrylate is preferably contained in the polymerizable component at a ratio of 20 to 90 wt %.

[Polymerizable Compound Having Low Surface Energy Group]

In the polymerizable compound having a low surface energy group, the low surface energy group means a functional group having a function of reducing surface free energy of the surface layer, and specifically means a silicone-modified or fluorine-modified acrylate group. Examples of such silicone-modified segment include dimethyl polysiloxane and methyl hydrogen polysiloxane, whereas examples of the fluorine-modified segment include polytetrafluoroethylene (PTFE) and tetrafluoroethylene-perfluoroalkylvinylether copolymer (PFA).

In the polymerizable compound having a low surface energy group, the polymerizable compound is a compound having radical polymerizability, for example, a compound having at least one radically polymerizable double bond.

Examples of the polymerizable compound having a low surface energy group include a vinyl copolymer with a number-average molecular weight of 5,000 or more and 100,000 or less, having at least one polyorganosiloxane chain or polyfluoroalkyl chain and at least three radically polymerizable double bonds. As such a polymerizable compound having a low surface energy group, commercially available products “Megafac” (manufactured by DIC Corporation) and “FulShade” (manufactured by Toyo Ink Co., Ltd.) can be used.

The polymerizable compound having a low surface energy group is preferably contained in the polymerizable component at a ratio of 1 to 30 wt %.

In a cured resin obtained by curing the above-mentioned polymerizable component through a polymerization reaction, the content ratio of structural units derived from the multifunctional (meth)acrylate is preferably 20 to 90 wt %.

When the polymerizable compound having a low surface energy group is used to form the surface layer, the content ratio of the structural unit derived from the polymerizable compound having a low surface energy group in a cured resin obtained is preferably 1 to 30 wt %.

When the polyurethane acrylate is used in combination to form the surface layer, the content ratio of the structural unit derived from the polyurethane acrylate in a cured resin obtained is preferably 20 to 50 wt %.

[Metal Oxide Microparticles]

Surface layer 4 preferably contains metal oxide microparticles having undergone a surface treatment (hereinafter, also referred to as “surface-treated metal oxide microparticles”). The surface-treated metal oxide microparticles contained in surface layer 4 enables surface layer 4 to obtain toughness, thus achieving high durability.

The surface-treated metal oxide microparticles can be obtained by surface-treating the metal oxide microparticles using a surface treating agent. The surface-treated metal oxide microparticles are preferably contained at a ratio of 5 to 40 parts by volume per 100 parts by volume of the polymerizable component.

As the metal oxide of the metal oxide microparticles for use in the present invention, any oxide of metals including transition metals may be employed, and examples thereof include silica (silicon oxide), magnesium oxide, zinc oxide, lead oxide, aluminum oxide, tantalum oxide, indium oxide, bismuth oxide, yttrium oxide, cobalt oxide, copper oxide, manganese oxide, selenium oxide, iron oxide, zirconium oxide, germanium oxide, tin oxide, titanium oxide, niobium oxide, molybdenum oxide, and vanadium oxide; among those, titanium oxide, alumina, zinc oxide, and tin oxide are preferred, and alumina and tin oxide are particularly preferred.

Examples of the surface treating agent for use in the surface treatment of the metal oxide microparticles include a compound having a radically polymerizable functional group. Examples of the radically polymerizable functional group include an acryloyl group and a methacryloyl group.

Further, in order to impart low surface energy characteristics, the surface treating agent may be also a silicone oil or a compound having a polyfluoroalkyl group. The silicone oil may be a straight silicone oil (e.g., methyl hydrogen polysiloxane (MHPS)), a modified silicone oil (e.g., one terminal carbinol-modified silicone oil or one terminal diol-modified silicone oil), or the like.

Examples of the photopolymerization initiator include 2-benzyl-2-dimethylamino-1-(4-morpholinophenyl)-butanone-1 (commercially available product: “IRGACURE 369” (manufactured by BASF Japan Ltd.)), 2-(dimethylamino)-2-[(4-methylphenyl)methyl]-1-[4-(4-morpholinyl)phenyl]-1-butanone (commercially available product: “IRGACURE 379” (manufactured by BASF Japan Ltd.)), bis(2,4,6-trimethylbenzoyl)-phenylphosphineoxide (commercially available product: “IRGACURE 819” (manufactured by BASF Japan Ltd.)), 2-hydroxy-1-{4-[4-(2-hydroxy-2-methyl-propionyl)-benzyl]phenyl}-2-methyl-propane-1-one (commercially available product: “IRGACURE 127” (manufactured by BASF Japan Ltd.)), and bis(η5-2,4-cyclopentadien-1-yl)-bis(2,6-difluoro-3-(1H-pyrrol-1-yl)-phenyl)titanium (commercially available product: “IRGACURE 784” (manufactured by BASF Japan Ltd.)).

Examples of the method of preparing the coating liquid for surface layer include, when adding a polymerizable component and a photopolymerization initiator to a solvent and further adding surface-treated metal oxide microparticles, a method in which the surface-treated metal oxide microparticles are added at a ratio of a solid content concentration of 3 to 10 wt %, followed by dispersion using, for example, a wet medium dispersion apparatus.

As the wet medium dispersion apparatus, various types of apparatuses such as vertical, horizontal, continuous, and batch type wet medium dispersion apparatuses can be employed. Specifically, sand mill, Ultra visco mill, Pearl mill, Grain mill, DINO-mill, Agitator mill, or Dynamic mill can be used. These dispersion apparatuses perform fine grinding and dispersion with pulverizing media such as balls or beads by means of impact crush, friction, shear force, and shear stress.

The coating liquid for surface layer preferably contains a solvent for the reason of satisfactory coatability (operability).

Examples of the solvent include ethanol, isopropanol, butanol, toluene, xylene, acetone, methyl ethyl ketone, ethyl acetate, butyl acetate, ethylene glycol diethyl ether, and propylene glycol monomethyl ether acetate.

Examples of the method of applying the coating liquid for surface layer include a dip coating method and a spray coating method.

The polymerizable component is polymerized by irradiation with curing light, and as a result a curing composition containing the polymerizable component is cured to generate a cured resin, to form a surface layer.

In the present invention, the curing light used for irradiating a coating film made from the coating liquid for surface layer is curing light emitted from an LED light source, which curing light includes neither light with a wavelength of less than 320 nm nor light with a wavelength of more than 405 nm, but includes light with a wavelength of 320 nm or more and 405 nm or less (hereinafter, also referred to as “specific curing light”).

When using light including light with a wavelength of less than 320 nm as curing light used for irradiating the coating film made from the coating liquid for surface layer, the total amount of heat generated by irradiation with the curing light is increased. Therefore, the crystal structure of polyphenylene sulfide resin composing the substrate layer is easily changed, which easily lowers the bending resistance as well as creep resistance of the intermediate transfer belt obtained, and as a result the durability as well as transfer quality of the intermediate transfer belt is likely to be insufficient. When using light including light with a wavelength of more than 405 nm as curing light used for irradiating the coating film made from the coating liquid for surface layer, the curing composition may not be cured sufficiently.

It is noted that heat generated by irradiation with the curing light refers to, for example, heat generated from a lamp itself that emits the curing light, or heat generated from the curing light per se.

The specific curing light is preferably light with a spectrum having a single peak, and particularly light with a spectrum having a single peak at a wavelength of 365 nm or 405 nm is preferred.

Use of light with a spectrum having a single peak as the specific curing light can further suppress the heat generated by irradiation with the specific curing light. Therefore, even when forming a surface layer having a large thickness, it is possible to obtain an intermediate transfer belt having excellent bending resistance and creep resistance.

As used herein, spectrum having a single peak refers to a spectrum has no other peak having a value of more than 10 when the base line is set at zero and the maximum value is set at 100 in the spectrum.

While the conditions for the irradiation with the specific curing light vary depending on the respective light sources, the dose of irradiation light is preferably 80 to 160 mW/cm², and more preferably 100 to 120 mW/cm², in consideration of curing unevenness, hardness, curing time, curing rate, and the like.

The time for the irradiation with the specific curing light is preferably 10 seconds to 8 minutes, and more preferably 30 seconds to 4 minutes in terms of curing efficiency, operation efficiency, and the like.

The coating liquid for surface layer is preferably dried after being applied onto the substrate layer, or after being applied onto the intermediate layer when the intermediate layer is provided. Thus, the solvent is removed.

The drying of the coating film may be performed during, before or after the polymerization of the polymerizable component, and these timings can be combined and appropriately selected. Specifically, it is preferable that a primary drying is performed to such an extent that there is no fluidity of the coating film, followed by polymerization of the polymerizable component, and subsequently a secondary drying is further performed so as to reduce the amount of a volatile material in the surface layer to a specified level.

Surface layer 4 preferably has a thickness of 1.0 μm or more and 5.0 μm or less, in consideration of the mechanical strength, image quality, production cost, and the like.

According to the above-described process for producing an intermediate transfer belt, a cured resin composing surface layer 4 is obtained by irradiating the polymerizable coating film for the cured product with the above-mentioned specific curing light, which therefore makes it possible to produce an intermediate transfer belt having excellent bending resistance and creep resistance, and thus having excellent durability and transfer quality.

This is because, an LED light source radiating the specific curing light hardly generates heat, and thus it becomes possible to limit the total amount of heat generated by irradiation with the specific curing light to a small amount, which therefore can extremely suppress changes in the crystal structure of the polyphenylene sulfide resin composing the substrate layer due to heat, even when curing is performed for a long period of time. Particularly, even when a long curing time is required, such as when a cured resin to constitute the surface layer is obtained using the polymerizable component containing a polyurethane acrylate, the total amount of heat generated by irradiation with the specific curing light can be limited to a small amount, and thus it is possible to obtain an intermediate transfer belt having excellent bending resistance and creep resistance.

It is noted that, when a workpiece having the coating film of the coating liquid for surface layer formed on the substrate layer is irradiated with curing light emitted from a high-pressure mercury lamp or a xenon lamp, the total amount of heat to be received by the substrate layer is considered to be larger than that in the present invention. This is because, even when limiting the wavelength of curing light used for irradiating the workpiece to 320 nm or more and 405 nm or less using, for example, a wavelength cut filter, the heat generated from the lamp itself cannot be cut off.

[Image Forming Apparatus]

The above-described intermediate transfer belt can be suitably used as an intermediate transfer belt in various known electrophotographic image forming apparatuses such as monochrome and full-color image forming apparatuses.

While the embodiment of the present invention has been described heretofore specifically, the embodiment of the present invention is not limited to the above-described examples, and various modifications can be made thereto.

According to the above-described process for producing the intermediate transfer belt, a cured resin composing the surface layer is obtained by irradiation with curing light including neither light with a wavelength of less than 320 nm nor light with a wavelength of more than 405 nm, but including light with a wavelength of 320 nm or more and 405 nm or less, and thus it is possible to produce an intermediate transfer belt having excellent bending resistance and creep resistance.

### EXAMPLES

Hereinafter, specific examples of the present invention will be described, but the present invention is not limited thereto.

### Example 1

### Intermediate Transfer Belt Production Example 1

### (1) Manufacture of Substrate Layer

### (1-1) Melting and Kneading of Material

Resin: Polyphenylene sulfide resin “E2180” (manufactured by Toray Industries, Inc.: crystallizable, melting point 280° C., glass transition point 90° C.) 100 parts by mass

Antioxidant: Phenol-based antioxidant “ADK STAB AO-50” (manufactured by ADEKA Corporation) 5 parts by mass

Conductive agent: Acetylene black “HS-100” (manufactured by DENKA) 16 parts by mass

Lubricant: Calcium montanate 0.2 parts by mass

A raw material composition containing the above-mentioned components in the above-mentioned amounts was melted and kneaded using a twin-screw kneading extruder “PMT 32” (manufactured by IKG Corporation) to obtain a resin pellet [1].

It is noted that the polyphenylene sulfide resin was dried for 8 hours at 130° C. in advance before kneading, then cooled to about 60° C., and used for the kneading.

### (1-2) Formation of Substrate Layer in Endless Belt Shape

The resin pellet [1] was dried for 8 hours at 130° C., and extruded, using a 40 mm diameter extruder provided with an annular die with 6 spiral grooves having a diameter of 150 mm and a lip clearance of 1 mm, downward from the annular die into a tube shape, which extruded unsolidified tube was brought into contact with the outer surface of a cooling mandrel with an outer diameter of 140 mm attached to the annular die coaxially via a support rod, thus cooling and solidifying the tube, to obtain a substrate layer material with an endless belt shape. The substrate layer material was drawn and stretched by a core provided inside the substrate layer material and a roll provided outside while being kept in a cylindrical shape, and was cut into a round piece at a length of 290 mm, to manufacture substrate layer [1] with an endless belt shape.

### (2) Formation of Surface Layer

### (2-1) Preparation of Coating Liquid for Forming Surface Layer

Multifunctional (meth)acrylate: Dipentaerythritol hexaacrylate (DPHA) 40 parts by mass

Polyurethane acrylate: “UV-3520TL” (manufactured by Nippon Synthetic Chemical Industry Co., Ltd.) 45 parts by mass

Polymerizable component having a low surface energy group: “Megafac” (manufactured by DIC Corporation) 10 parts by mass

Surface-treated metal oxide microparticles: tin oxide microparticles surface-treated with a surface treating agent (CH₂═CHCOO(CH₂)₂Si(OCH₃)₃) 5 parts by mass

The above-mentioned components in the above-mentioned amounts were dissolved or dispersed in a solvent, propylene glycol monomethyl ether acetate (PMA), such that the solid content concentration was 10 mass %, to prepare a coating liquid for surface layer [1].

### (2-2) Coating and Curing

5 parts by mass of a photopolymerization initiator “IRGACURE 379” (manufactured by BASF Japan Ltd.) were charged into the coating liquid for surface layer [1], and after dissolution a sprayer manufactured by YD mechatro solutions Inc. was used to perform spray coating on the outer peripheral surface of the above-mentioned substrate layer [1] such that the dried film thickness was 2 μm under the coating conditions mentioned below, to thereby form a coating film. The coating film was irradiated with curing light having a spectrum with a single peak at a wavelength of 365 nm under the irradiation conditions mentioned below, thereby curing the coating film to form a surface layer, and as a result an intermediate transfer belt [1] was obtained. The irradiation with curing light was performed while fixing the light source and rotating the substrate layer [1] having the coating film formed on the outer peripheral surface thereof at a circumferential speed of 60 mm/s.

—Spray Coating Conditions—

Nozzle scanning speed: 1 to 10 mm/sec

Nozzle distance: 100 to 150 mm

Number of nozzle: 1

Coating liquid supply amount: 1 to 5 mL/min

O₂ flow rate: 2 to 6 L/min

—Curing Light Irradiation Conditions—

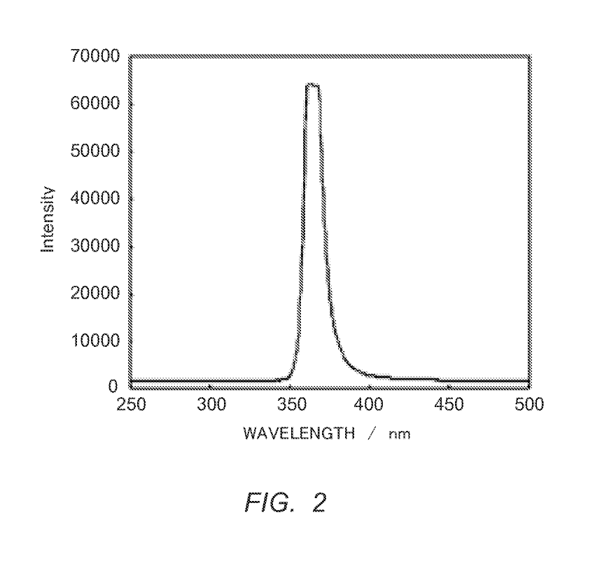

Type of light source: UV-LED lamp “UV-SPV series” (manufactured by Revox Inc., light with the spectrum illustrated in FIG. 2)

Distance from irradiation hole to the surface of the coating film: 40 mm

Dose of irradiation light: 100 mW/cm²

Irradiation time (time during which the substrate is rotated): 150 seconds

### Examples 2 to 5

### Intermediate Transfer Belt Production Examples 2 to 5

Intermediate transfer belts [2] to [5] were manufactured in the same manner as in the intermediate transfer belt production example 1 except that the thickness of the surface layer was changed to the value described in Table 1.

### Example 6

### Intermediate Transfer Belt Production Example 6

Intermediate transfer belt [6] was manufactured in the same manner as in the intermediate transfer belt production example 1 except that “IRGACURE 127” (manufactured by BASF Japan Ltd.) was used as a photopolymerization initiator, and that the curing light was changed to light with a spectrum having a single peak at a wavelength of 320 nm.

### Example 7

### Intermediate Transfer Belt Production Example 7

Intermediate transfer belt [7] was manufactured in the same manner as in the intermediate transfer belt production example 1 except that “IRGACURE 784” (manufactured by BASF Japan Ltd.) was used as a photopolymerization initiator, and that the curing light was changed to light with a spectrum having a single peak at a wavelength of 405 nm.

### Examples 8 and 9

### Intermediate Transfer Belt Production Examples 8 and 9

Intermediate transfer belts [8] and [9] were manufactured in the same manner as in the intermediate transfer belt production example 1 except that the polyurethane acrylate for use in the formation of the surface layer was changed to “UV-3000B” (manufactured by Nippon Synthetic Chemical Industry Co., Ltd.) or “UV-3200B” (manufactured by Nippon Synthetic Chemical Industry Co., Ltd.).

### Example 10

### Intermediate Transfer Belt Production Example 10

Intermediate transfer belt [10] was manufactured in the same manner as in the intermediate transfer belt production example 1 except that the polyurethane acrylate was not used for the formation of the surface layer.

### Comparative Example 1

### Intermediate Transfer Belt Production Example 11

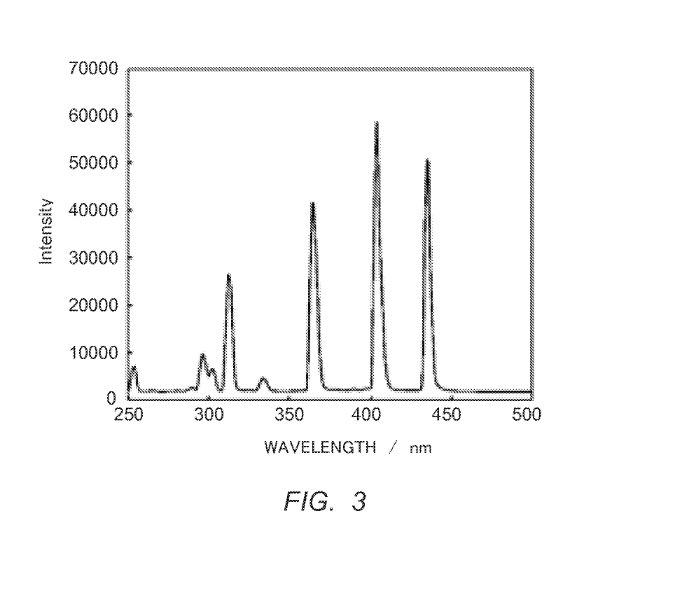

Comparative intermediate transfer belt [11] was manufactured in the same manner as in the intermediate transfer belt production example 1 except that a high-pressure mercury lamp was used as a light source of the curing light, and that the curing light was changed to light with the spectrum having a plurality of peaks illustrated in FIG. 3.

### Comparative Example 2

### Intermediate Transfer Belt Production Example 12

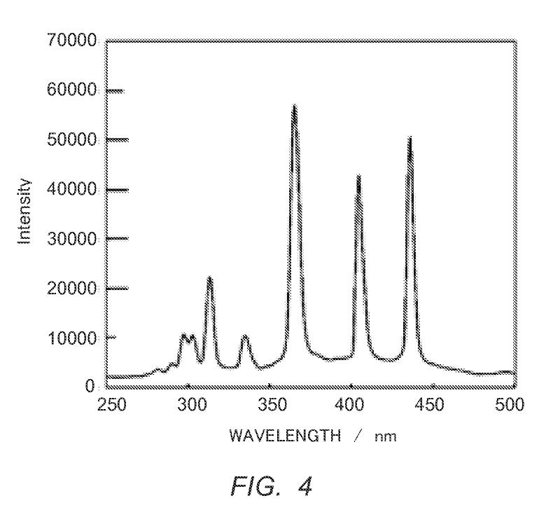

Comparative intermediate transfer belt [12] was manufactured in the same manner as in the intermediate transfer belt production example 1 except that a xenon lamp was used as a light source of the curing light, and that the curing light was changed to light with the spectrum having a plurality of peaks illustrated in FIG. 4.

### Comparative Example 3

### Intermediate Transfer Belt Production Example 13

Comparative intermediate transfer belt [13] was manufactured in the same manner as in the intermediate transfer belt production example 1 except that “IRGACURE 127” (manufactured by BASF Japan Ltd.) was used as a photopolymerization initiator, and that the curing light was changed to light with a spectrum having a single peak at a wavelength of 300 nm.

### Comparative Example 4

### Intermediate Transfer Belt Production Example 14

Comparative intermediate transfer belt [14] was manufactured in the same manner as in the intermediate transfer belt production example 1 except that “IRGACURE 784” (manufactured by BASF Japan Ltd.) was used as a photopolymerization initiator, and that the curing light was changed to light with a spectrum having a single peak at a wavelength of 440 nm.

[Evaluation 1: Bending Resistance]

Each of the intermediate transfer belts [1] to [14] was measured in terms of bending number with a measurement method in accordance with JIS P-8115 using “MIT-DA” (Toyo Seiki Seisaku-Sho, Ltd.). Each sample (intermediate transfer belt) was measured three times, and the average value (2 significant digits) of the obtained measurement values was defined as a representative value. The bending number was evaluated according to evaluation criteria described below. The results are shown in Table 1. The bending number is a measure of flexural fatigue, and a larger bending number means that a sample does not easily crack and is tough.

### —Evaluation Criteria—

A: the bending number is 20,000 or more (pass)

B: the bending number is 15,000 or more and less than 20,000 (pass)

C: the bending number is 10,000 or more and less than 15,000 (fail)

D: the bending number is less than 10,000 (fail)

[Evaluation 2: Creep Resistance]

Each of the intermediate transfer belts [1] to [14] was cut into a piece having a size of a width of 50 mm and a length of 130 mm to manufacture a test piece. The test piece was measured in terms of an initial state dimension (a), subsequently inserted into an aluminum pipe with an inner diameter φ of 28 mm by rounding the test piece, left to stand for 100 hours under the environment of a temperature of 40° C. and a humidity of 95% RH, then left to stand for 12 hours under the environment of a temperature of 23° C. and a humidity of 50% RH, and afterward extracted from the aluminum pipe, and dimension (b) of the test piece was immediately measured. A creep ratio was calculated from the dimensions (a) and (b) using numerical expression (1) mentioned below to evaluate the creep resistance according to the evaluation criteria mentioned below. The results are shown in Table 1.

Creep ratio (%)=(a−b)/(a−X)×100 Numerical expression (1):

wherein, X denotes a dimension of an overlapped portion of the test piece inside the aluminum pipe, and, in this evaluation, X is {length 130 mm−(aluminum pipe inner diameter φ 28 mm×π)}.

Lower creep ratio means smaller curl of the test piece. For example, when the creep ratio is 75% or more, density unevenness easily occurs, and when the creep ratio is 80% or more, obvious density unevenness occurs.

### —Evaluation Criteria—

A: less than 40% (passed)

B: 40% or more and less than 75% (passed)

C: 75% or more and less than 80% (rejected)

D: 80% or more (rejected)

TABLE 1

| | | | | | Surface | | |
|---|---|---|---|---|---|---|---|
| | Intermediate | | Curing light | | layer | Evaluation results | |
| | transfer belt | Polyurethane | | Wavelength | Thickness | Bending | Creep |
| | No. | acrylate | Light source | [nm] | [μm] | resistance | resistance |
| Ex. 1 | 1 | UV-3520TL | LED lamp | 365 | 0.5 | B | B |
| Ex. 2 | 2 | | | | 1 | A | A |
| Ex. 3 | 3 | | | | 2 | A | A |
| Ex. 4 | 4 | | | | 5 | A | A |
| Ex. 5 | 5 | | | | 8 | B | A |
| Ex. 6 | 6 | | | 320 | 2 | B | A |
| Ex. 7 | 7 | | | 405 | 2 | A | A |
| Ex. 8 | 8 | UV-3000B | | 365 | 2 | A | A |
| Ex. 9 | 9 | UV-3200B | | | 2 | A | A |
| Ex. 10 | 10 | None | | | 2 | A | A |
| Comp. | 11 | UV-3520TL | High-pressure | 250-440 | 2 | D | C |
| Ex. 1 | | | Mercury lamp | | | | |
| Comp. | 12 | | Xenon lamp | 320-440 | 2 | D | B |
| Ex. 2 | | | | | | | |
| Comp. | 13 | | LED lamp | 300 | 2 | C | C |
| Ex. 3 | | | | | | | |
| Comp. | 14 | | | 440 | 2 | C | B |
| Ex. 4 | | | | | | | |

What is claimed is:

1. A process for producing an intermediate transfer belt for transferring a toner image formed on a photoconductor to a recording medium in an electrophotographic image forming apparatus, the intermediate transfer belt having a surface layer which comprises a cured resin on a substrate layer comprising polyphenylene sulfide, the process comprising:
irradiating a coating film formed by coating a surface of the substrate layer with a curing composition containing a polymerizable component, with curing light emitted from an LED light source, the curing light including neither light with a wavelength of less than 320 nm nor light with a wavelength of more than 405 nm, but includes light with a wavelength of 320 nm or more and 405 nm or less, to form the surface layer comprising the cured resin by polymerization of the polymerizable component.

2. The process for producing an intermediate transfer belt according to claim 1, wherein the curing light is light with a spectrum having a single peak.

3. The process for producing an intermediate transfer belt according to claim 1, wherein the polymerizable component contains a polyurethane acrylate.

4. The process for producing an intermediate transfer belt according to claim 1, wherein the polymerizable component contains a multifunctional (meth)acrylate having at least two (meth)acryloyloxy groups in a molecule.

5. The process for producing an intermediate transfer belt according to claim 1, wherein the surface layer has a thickness of 1.0 μm or more and 5.0 μm or less.
